(19) United States
(12) Patent Application Publication
(10) Pub. No.: US 2015/0365453 A1
(43) Pub. Date: Dec. 17, 2015

(54) MEDIA PROJECTION METHOD AND DEVICE, CONTROL TERMINAL AND CLOUD SERVER

(71) Applicant: Alibaba Group Holding Limited, Grand Cayman (KY)

(72) Inventor: Dongwu Cheng, Hangzhou (CN)

(21) Appl. No.: 14/734,980

(22) Filed: Jun. 9, 2015

(30) Foreign Application Priority Data
Jun. 11, 2014 (CN) 201410259388.7

(51) Int. Cl. H04L 29/06

(52) U.S. Cl. CPC H04L 65/4092

(57) ABSTRACT

A media projection method, a media projection device, a control terminal, and a cloud server are disclosed. The media projection method includes: establishing a playback control channel between a control terminal and a media projection device; sending, by the control terminal, a media playback request message to the media projection device over the playback control channel to cause the media projection device to enable a service of playing a corresponding media resource according to the media playback request message. The present disclosure can rapidly realize multi-screen interaction of third-party videos.

### CROSS REFERENCE TO RELATED PATENT APPLICATION

This application claims foreign priority to Chinese Patent Application No. 201410259388.7 filed on Jun. 11, 2014, entitled “Media Projection Method and Device, Control Terminal and Cloud Server”, which is hereby incorporated by reference in its entirety.

### TECHNICAL FIELD

The present disclosure relates to the technological field of video playback control, and particularly relates to media projection methods, media projection devices, control terminals, and cloud servers.

### BACKGROUND

With the development of mobile Internet technologies and multimedia technologies, more and more video resources are available for control terminal devices (mobile phones, smart phones, and tablet computers). Users can select video resources according to their preferences. However, due to the portability, control terminal devices usually have a small screen, which affects the video viewing experience.

A multi-screen interaction technology provides operations of interaction among smart devices. A user may project media on a smart control terminal to a television for playback to obtain better experience. Currently, protocols supporting multi-screen interaction include DLNA, AirPlay, IGRS, and the like. However, these protocols are neither compatible nor interoperable with each other, and different companies need to develop their own technologies to be compatible with different protocols in order to achieve real multi-screen interaction across platforms.

In addition, third-party videos have different requirements on a player, and a video player cannot support all types of videos. Third-party video operators are more willing to customize their own players to provide better user experience, attract more users, and gain more commercial benefits.

Currently, third-party video applications that provide Internet media are independent client ends, which implement the projection of third-party videos from the Internet by integrating a DLNA function.

The Digital Living Network Alliance (DLNA) was established by Sony, Intel and Microsoft, etc., and aims at resolving the interoperability of wireless networks and wired networks including personal computers, consumer electrical appliances, and mobile devices, and achieving the transmission of digital multimedia (high-resolution videos, audios, and pictures) content, which can synchronize content displayed on different screens and implement a series of operations such as controlling a device via a smart terminal.

DLNA video projection needs interaction among the following devices:

(1) Digital Media Control (DMC): a controller in a home network and having DMR and DMS device capabilities.

(2) Digital Media Render (DMR): a player in the home network and being responsible for playing media content.

(3) Digital Media Server (DMS): a media server in the home network.

An interaction process of media content projection is given as follows:

(1) The DMC browses media content shared on the DMS.

(2) The DMC selects media content.

(3) The DMC sends a link of the selected media content to the DMR and requests for playback.

The DLNA protocol is mainly applied to a home network environment. Since media shared on the DMS is mainly media content stored in the device itself, video resources are limited and are not as abundant as videos on the Internet. When a user wants to watch the latest video, the user needs to download the content locally for sharing and watching.

Currently, third-party videos presented by a mobile phone are all presented as individual applications. Basic functional components of the DLNA, which are integrated in an application, perform device discovery, network connection, media control, etc., to realize multi-screen interaction.

The DLNA-based video projection has the following defects:

(1) A third-party video client side needs to implement the DMC function, and a target device (TV) of projection needs to support the DMR function, which results in a relatively high cost for development and maintenance.

(2) Different third-party videos have different requirements on the DMR of the target device (TV) of projection, which needs to be updated and maintained constantly to support the projection of new videos.

(3) As a standard device, the DMR of the target device (TV) of projection has simple interface functions and cannot be extended easily, thus gaining no commercial benefits from the third-party videos.

(4) Third-party video client ends are independent applications, and switching applications and selecting projection content are needed in order to view video resources.

### SUMMARY

An objective of the present disclosure is to provide a media projection method, a media projection device, a control terminal and a cloud server to overcome the aforementioned problems in existing technologies. This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure. In order to solve the above problems, embodiments of the present disclosure provide a media projection method. The method may include: establishing a playback control channel between a control terminal and a media projection device; and sending a media playback request message from the control terminal to the media projection device via the playback control channel to cause the media projection device to start a service of playing a corresponding media resource according to the media playback request message.

The embodiments of the present disclosure further provide a media projection method, which may include: establishing a playback control channel between a media projection device and a control terminal; the media projection device receiving a media playback request message from the control terminal via the playback control channel; and the media projection device initiating a service of playing a corresponding media resource according to the received media playback request message.

The embodiments of the present disclosure further provide a media projection method, which may include: establishing a streaming media channel between a cloud server and a media projection device; the cloud server receiving a media resource request message from the media projection device; and the cloud server searching for a corresponding media resource according to the media resource request message and sending the corresponding media resource that is found to the media projection device over the streaming media channel.

The embodiments of the present disclosure further provide a control terminal. The control terminal may include: a first playback control channel establishing module to establish a playback control channel between the control terminal and a media projection device; and a sending module to send a media playback request message to the media projection device via the playback control channel to cause or instruct the media projection device to activate a service of playing a corresponding media resource according to the media playback request message.

The embodiments of the present disclosure further provide a media projection device. The media projection device may include: a second playback control channel establishing module to establish a playback control channel between the media projection device and a control terminal; a receiving module to receive a media playback request message from the control terminal via the playback control channel; and a playback service module to initiate a service of playing a corresponding media resource according to the media playback request message received by the receiving module.

The embodiments of the present disclosure further provide a cloud server. The cloud server may include: a second streaming media channel establishing module to establish a streaming media channel between the cloud server and a media projection device; a receiving module to receive a media resource request message that is sent from the media projection device; and a sending module to search for a corresponding media resource according to the media resource request message, and to send the corresponding media resource that is found to the media projection device over the streaming media channel.

Compared with the existing technologies, the foregoing technical solutions of the present disclosure establish a unified playback control channel between a control terminal and a media projection device, and send a media playback request message via the playback control channel to allow the media projection device to activate a service of playing a corresponding media resource according to the media playback request message, thus implementing multi-screen interaction of third-party videos rapidly and achieving personalized video playback and interaction experience while reducing the cost for development and maintenance of the third-party videos.

### BRIEF DESCRIPTION OF THE DRAWINGS

Accompanying drawings illustrated herein are used for providing a further understanding of the present disclosure and constitute a part of the present disclosure. Exemplary embodiments of the present disclosure and a description thereof are used for explaining the present disclosure, and are not meant to unduly limit the present disclosure. In the drawings:

FIG. 1 is a flowchart of an example media projection method in accordance with the present disclosure.

FIG. 2 is a schematic diagram of an example device discovery process in accordance with the present disclosure.

FIG. 3 is a schematic diagram of an example process of establishing a device connection in accordance with the present disclosure.

FIG. 4 is a schematic diagram of acquiring and maintaining a media resource in accordance with an embodiment of the present disclosure.

FIG. 5 is a flowchart of an example media projection method in accordance with the present disclosure.

FIG. 6 is a structural diagram of an example control terminal in accordance with the present disclosure.

FIG. 7 is a structural diagram of an example media projection device in accordance with the present disclosure.

FIG. 8 is a structural diagram of an example cloud server in accordance with the present disclosure.

FIG. 9 is a structural diagram of an example media projection system in accordance with the present disclosure.

FIG. 10 is a structural diagram of a media projection system in accordance with an example of the present disclosure.

FIG. 11 is a schematic diagram of a “video” application that presents video information in a mobile phone in accordance with an example of the present disclosure.

FIG. 12 is a structural diagram of an apparatus as described in FIGS. 6-9 in more detail.

### DETAILED DESCRIPTION

In the present disclosure, a unified playback control channel is established between a control terminal and a media projection device. A media playback request message is sent via the playback control channel to instruct or request the media projection device to start a service of playing a corresponding media resource according to the media playback request message. By using the present disclosure, personalized video playback and interaction experience is achieved while reducing the cost for development and maintenance of third-party videos.

In order to explain the objectives, technical solutions, and advantages of the present disclosure in a clearer manner, the technical solutions of the present disclosure will be clearly and fully described herein with reference to exemplary embodiments of the present disclosure and accompanying drawings. Apparently, the described embodiments merely represent a part of, and not all of, the embodiments of the present disclosure. All other embodiments that are obtained by one of ordinary skill in the art based on the embodiments in the present disclosure without making any creative efforts should belong to the protection scope of the present disclosure.

In the present disclosure, a control terminal refers to a device that implements a projection control, which includes, but is not limited to, a mobile phone, a smart phone, a tablet computer, a computing device, etc. A media projection device may play media resources such as videos, audios, pictures, and web pages, etc. The media projection device may include, but is not limited to, a device such as a television, a smart television, a tablet computer, etc. For example, in an event that the control terminal is a smart phone, the media projection device may be a television or a tablet computer. If the control terminal is a tablet computer, the media projection device may be a television.

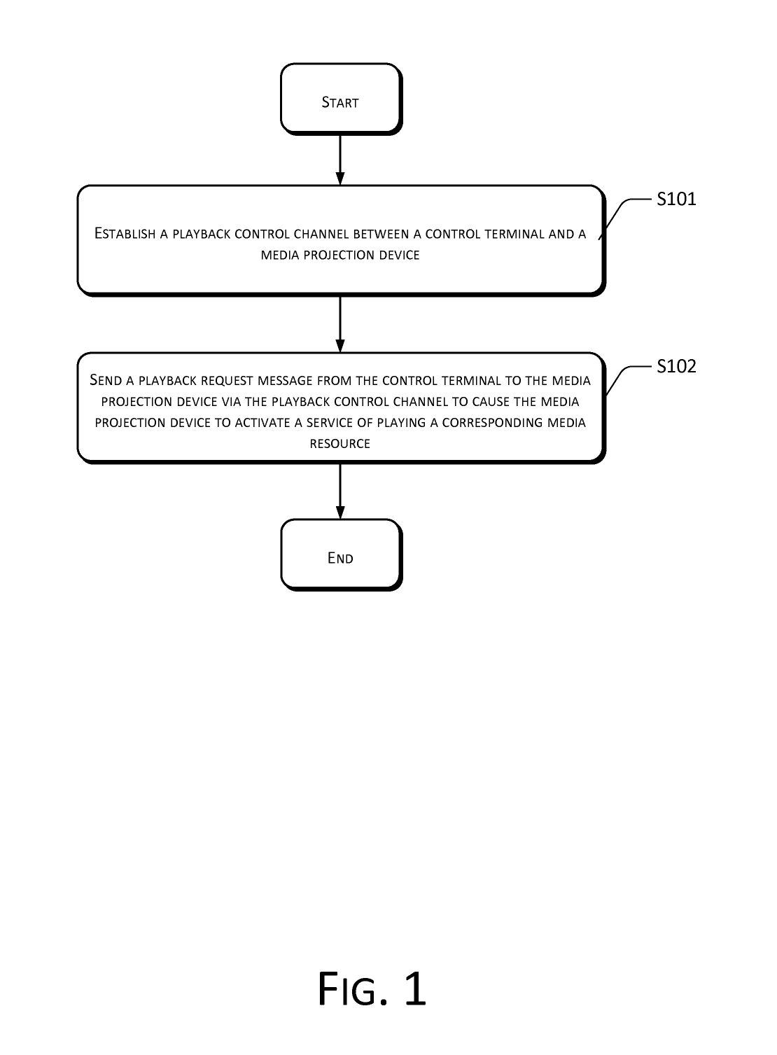

FIG. 1 shows a flowchart of an example media projection method in accordance with the present disclosure. As shown in FIG. 1, the method may include:

At S102, a playback control channel is established between a control terminal and a media projection device.

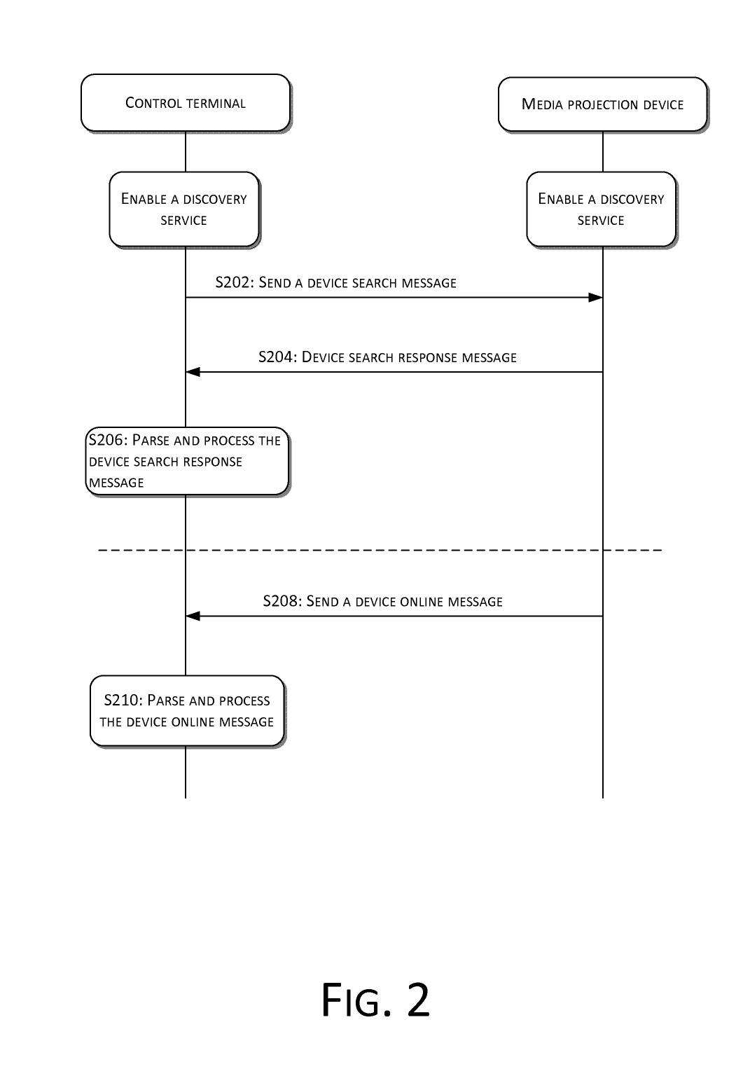

In an embodiment of the present disclosure, the control terminal and the media projection device may be set up in a same local area network. The control terminal and the media projection device may specify one or more multicast addresses and ports, and individually activate respective device discovery services. A discovery service of the control terminal may send a device search message, and a device discovery service of the media projection device may announce or broadcast a device online message. FIG. 2 shows a schematic diagram of a device discovery process according to an embodiment of the present disclosure. Due to an order of activating device discovery services, the discovery of a media projection device by a smart terminal (i.e., the control terminal) may include two scenarios as described as follows. The first one corresponds to: the control terminal sending a device search message (block S202); the media projection device returning a response message upon receiving the device search message (block S204); and the control terminal parsing and processing the media projection device that is online (block S206), thus discovering the media projection device. The second one corresponds to: the media projection device sending a device online message (block S208); and the control terminal parsing and processing the device online message in response to receiving the message (block S210), thus discovering the media projection device.

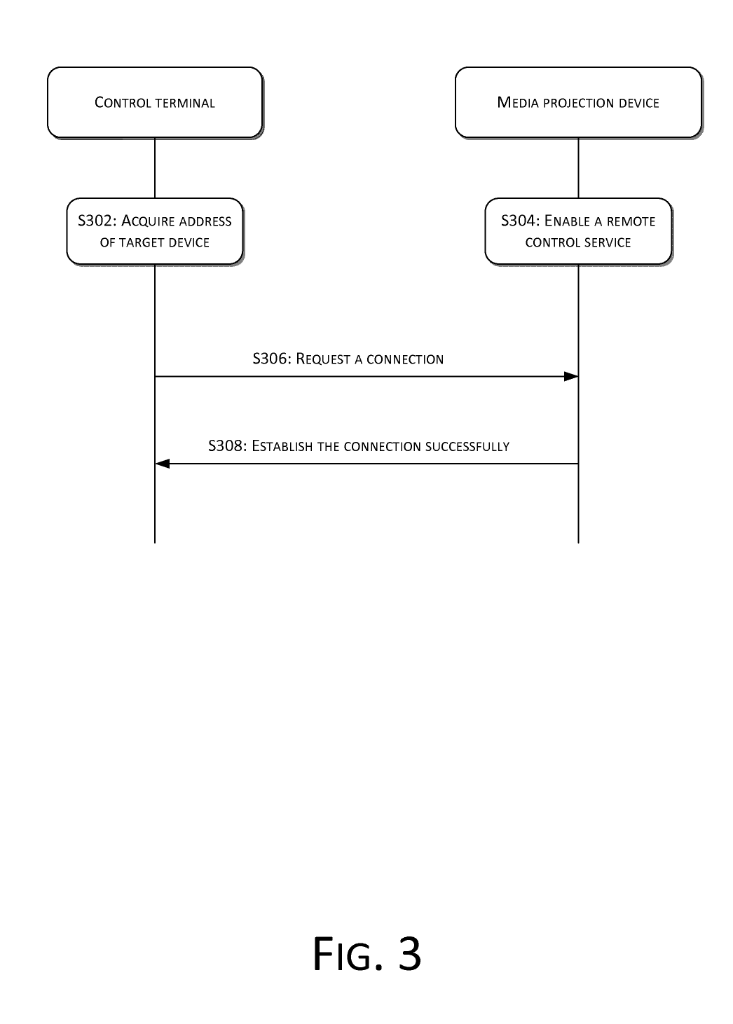

In response to discovering the media projection device, the control terminal may establish a connection between the control terminal and the media projection device, and establish a playback control channel based on the connection. FIG. 3 shows a schematic diagram of a process of establishing a device connection according to an embodiment of the present disclosure. Specifically, after the control terminal discovers the media projection device, the control terminal acquires an Internet Protocol (IP) address of a target device (i.e., the media projection device) (block S302). The media projection device may then start a remote control service (block S304), and the control terminal sends a connection request message to the media projection device (block S306). In a real application, the control terminal may establish a Transmission Control Protocol (TCP) persistent connection for inter-device communications based on the IP address of the media projection device. The media projection device receives the connection request message, processes the connection request of the (smart) terminal device, and establishes the TCP persistent connection with the terminal device. In an embodiment, the media projection device may act as a server-side device, and the control terminal may act as a client-side device. In this way, the connection between the control terminal and the media projection device is established successfully (block S308). A playback control channel may be established based on the persistent connection accordingly.

In another embodiment of the present disclosure, the control terminal and the media projection device may not be located in a same local area network. In this case, the control terminal may establish a remote connection based on an IP address and port of the media projection device, and establishes a playback control channel based on the remote connection. Furthermore, in an embodiment, the control terminal may establish remote connections with a plurality of media projection devices. The control terminal may individually establish a plurality of playback control channels with the plurality of media projection devices. In an embodiment, the control terminal may act as a control-side device to control the plurality of projection devices to play a same media resource simultaneously or synchronously.

At S104, the control terminal sends a media playback request message to the media projection device via the playback control channel, and the media projection device activates a service of playing a corresponding media resource according to the media playback request message.

In an embodiment of the present disclosure, the media playback request message may include information needed for playing the media resource. The media projection device may activate the playback service after acquiring the media resource through a corresponding device based on the media playback request message.

In an embodiment of the present disclosure, under a circumstance that the control terminal controls a plurality of projection devices to play a media resource simultaneously, a plurality of playback control channels may separately be established between the control terminal and the plurality of media projection devices. The control terminal may send media playback request message(s) to the plurality of media projection devices via the plurality of playback control channels respectively. The control terminal may control the plurality of media projection devices to play a same media resource or different media resources by sending the media playback request message(s).

In another embodiment of the present disclosure, the control terminal may present presentation information corresponding to the media resource that is played by the media projection device in a display screen thereof. The presentation information may be obtained from a media distribution server that is connected to the control terminal. The media distribution server may maintain the presentation information of the media resource according to the media resource provided by an associated media provider. The media distribution server may include a query module, an addition module, a deletion module and a modification module (not shown), etc., to implement functions of querying, adding, deleting and modifying third-party media resources respectively. Furthermore, the media distribution server may accept a query from the control terminal, and allow the control terminal to acquire the presentation information of the media resource from the media distribution server.

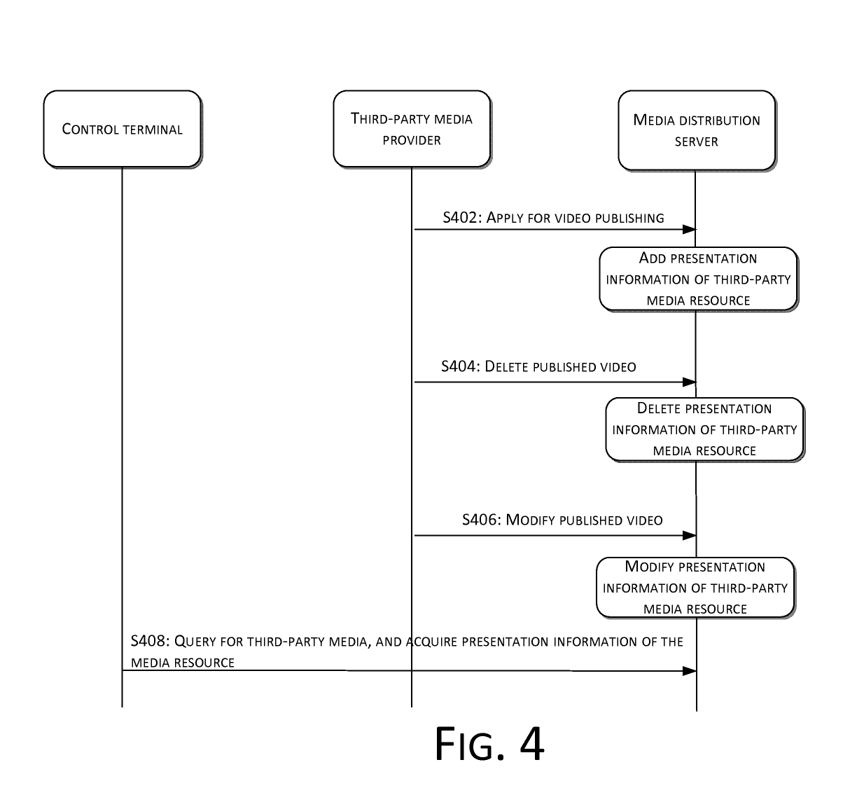

Referring to FIG. 4, an independent third party may provide presentation information of a third-party media resource that is maintained by the media distribution server. The media distribution server maintains presentation information of a third-party media resource according to the media resource provided by a media provider. As shown in FIG. 4, this may include: the third-party media provider submitting a request for publishing media information to the media distribution server, and the media distribution server locally adding corresponding display information of a media resource (block S402); the third-party media provider submitting a request for deleting media information to the media distribution server, and the media distribution server locally deleting corresponding display information of a media resource (block S404); and/or the third-party media provider submitting a request for modifying media information to the media distribution server, and the media distribution server locally modifying corresponding display information of a media resource (block S406).

In a real application, a third-party media resource maintained by the media distribution server may include, but is not limited to, video information, audio information, and media playback information (which may include a title, a brief introduction, an icon URL, etc.). In addition, the media distribution server may post all media resource information for the control terminal device to query and obtain via a home page.

Still referring to FIG. 4, the control terminal device queries for published third-party media (block S408). Media information that is returned in response to the query from the control terminal may include information such as a third-party media title, a media icon URL, a home page, etc. The control terminal device performs presentation based on the returned information and presents the display information of the third-party media of the media distribution server using a home page link.

After the media projection device activates the service of playing a media resource (block S104), the method may further include: the control terminal sending a media control message to one or more media projection devices via the playback control channel(s), and the one or more media projection devices performing a corresponding media control operation according to the media control message. The media control message may include a playback stop message and/or a playback switch message. According to the foregoing embodiments, the control terminal sends various types of playback control commands to the one or more media projection devices via the playback control channel(s) to cause or instruct the projection devices to complete corresponding operations.

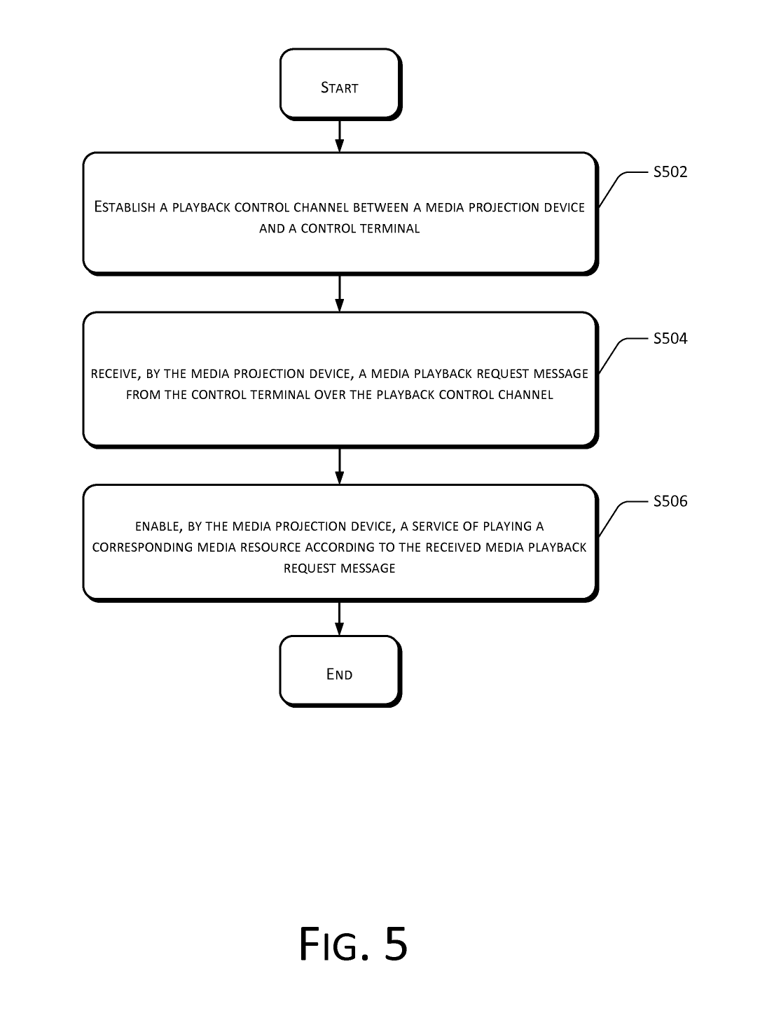

FIG. 5 shows a flowchart of a media projection method according to another embodiment of the present disclosure. As shown in FIG. 5, the method may include:

At S502, a playback control channel is established between a media projection device and a control terminal.

Specifically, after a media projection device is discovered by a control terminal, the media projection device enables a remote control service, and establishes a Transmission Control Protocol (TCP) persistent connection for inter-device communications, with the media projection device acting as a server-side device and the control terminal acting as a client-side device. In this way, the connection between the media projection device and the control terminal is successfully established, and thereby a playback control channel is established based on the persistent connection.

At S504, the media projection device receives a media playback request message from the control terminal via the playback control channel.

At S506, the media projection device enables a service of playing a corresponding media resource according to the received media playback request message.

In the present disclosure, a cloud server is used for storing media resources. The media projection device may acquire a corresponding media resource from the cloud server connected thereto. First, a streaming media channel is established between the media projection device and the cloud server. The media projection device then sends a media resource request message for acquiring a corresponding media resource to the cloud server according to the media playback request message. Thereafter, the media projection device receives the media resource over the streaming media channel, and plays the media resource.

In the present disclosure, the cloud server is further used for maintaining a plurality of types of media players. The types of media players include: a video player, an audio player, a picture player, and a web page player. Furthermore, a plurality of types of video players may exist. In the present disclosure, each video resource is played by a corresponding video player. In response to acquiring the media resource, the media projection device determines a media type of the media resource, downloads and installs a media player that corresponds to the type of the media resource from the cloud server. The media projection device therefore plays the content of the media resource using the corresponding media player.

After the media projection device enables the service of playing the media resource, the method may further include: the media projection device receiving a media control message from the control terminal via the playback control channel, the media control message including a playback stop message and/or a playback switch message; and the media projection device performing a corresponding media control operation according to the media control message.

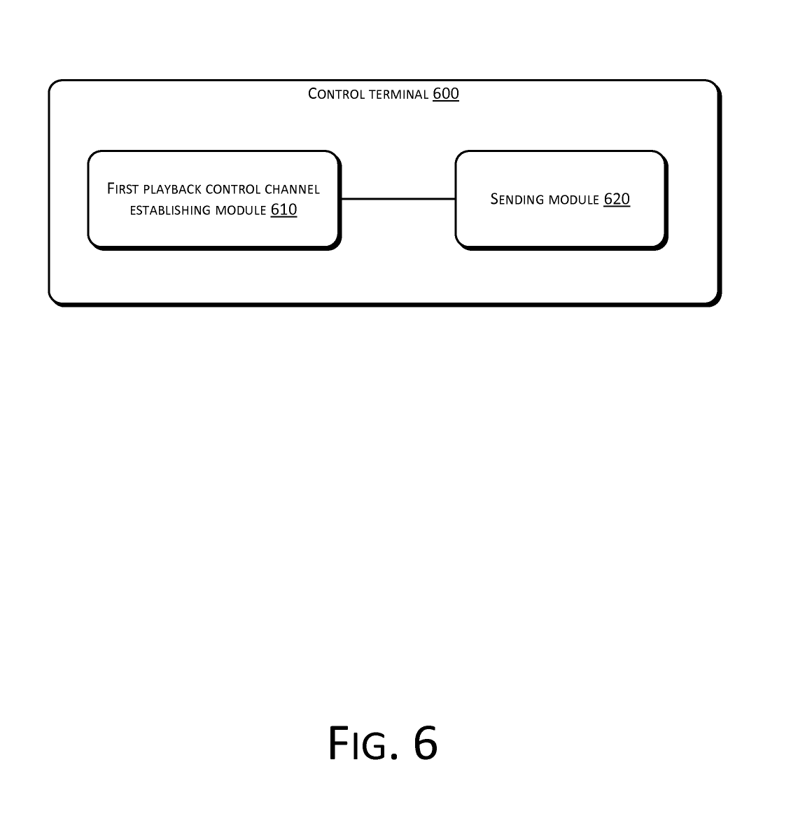

FIG. 6 shows a structural block diagram of a control terminal according to an embodiment of the present disclosure. Referring to FIG. 6, the control terminal 600 may include: a first playback control channel establishing module 610 and a sending module 620.

The first playback control channel establishing module 610 is configured to establish a playback control channel between the control terminal and a media projection device. The sending module 620 is configured to send a media playback request message to the media projection device over the playback control channel, the media projection device enabling a service of playing a corresponding media resource according to the media playback request message.

According to an embodiment of the present disclosure, the first playback control channel establishing module 610 is further configured to individually establish a plurality of playback control channels between the control terminal and a plurality of media projection devices. The sending module 620 is further configured to send media control message(s) to the corresponding media projection devices over the plurality of playback control channels, so that the media projection devices perform a corresponding media control operation, wherein the media control message includes: a playback stop message and/or a playback switch message.

After the control terminal establishes the playback control channel with the media projection device, the control terminal acquires an instance of inter-device communication. The control terminal opens the playback control channel for a third-party media, sets a channel monitoring function to monitor the media projection device. If a message of enabling a video player of the media projection device is detected, an operation such as starting a projection, stopping or switching a playback, etc., may be performed. If a message of disabling the video player of the media projection device is detected, the projection of the media is no longer continued.

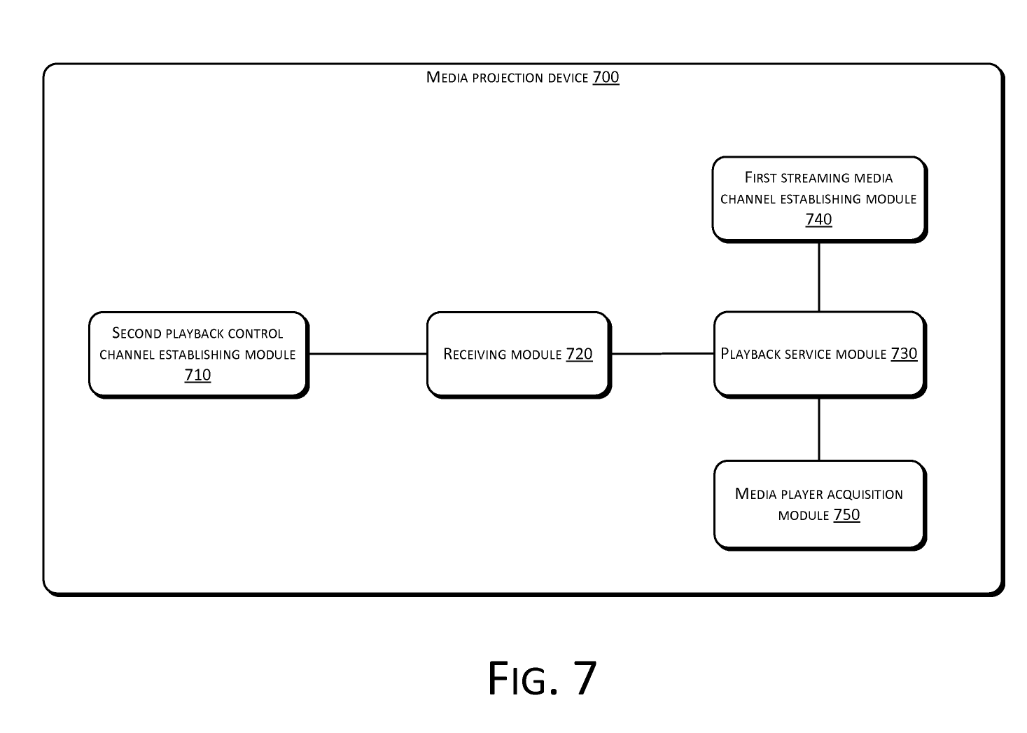

FIG. 7 shows a structural block diagram of a media projection device according to an embodiment of the present disclosure. As shown in FIG. 7, the media projection device 700 may include: a second playback control channel establishing module 710, a receiving module 720, a playback service module 730, a first streaming media channel establishing module 740, and a media player acquisition module 750.

The second playback control channel establishing module 710 is configured to establish a playback control channel with a control terminal.

The receiving module 720 is configured to receive a media playback request message that is sent by the control terminal via the playback control channel.

The playback service module 730 is configured to initiate a service of playing a corresponding media resource according to the media playback request message received by the receiving module 720.

The first playback control channel establishing module 610 and the second playback control channel establishing module 710 cooperate to establish the playback control channel.

The first streaming media channel establishing module 740 is configured to establish a streaming media channel between the media projection device and a cloud server. The playback service module 730 sends a media resource request message for acquiring the corresponding media resource to the cloud server according to the media playback request message, receives the media resource over the streaming media channel, and plays the media resource.

The media player acquisition module 750 is configured to determine a type of the media resource, and acquire a media player for playing media resources of the type from the cloud server that is connected to the media projection device. Based thereon, the playback service module 730 uses the acquired media player to play the media resource.

According to an embodiment of the present disclosure, the receiving module 720 is further configured to receive a media control message from the control terminal via the playback control channel, and perform corresponding media control operations, wherein the media control message includes: a playback stop message and/or a playback switch message. The playback service module 730 is further configured to execute a corresponding media control operation.

After the media projection device 700 establishes a playback control channel with the control terminal, the media projection device 700 monitors message(s) sent over a TCP persistent connection, and starts a third-party video playback control service in response to receiving a request for starting a third-party video playback. The third-party video playback control service that is started by the media projection device then monitors online and/or offline message(s) of the control terminal (corresponding client side). If the third-party video playback control service receives an online message of the control terminal and receives a message from the client side, the third-party video playback control service parses the message and implements a video playback control. If the third-party video playback control service receives an offline message of the control terminal, the third-party video playback control service is disabled.

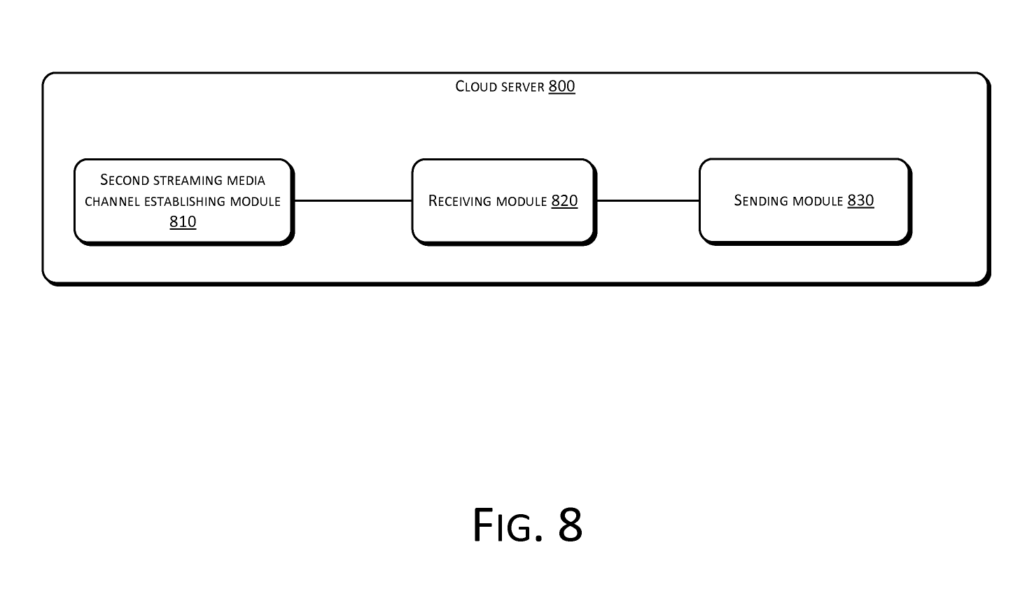

FIG. 8 shows a structural block diagram of a cloud server according to an embodiment of the present disclosure. As shown in FIG. 8, the cloud server 800 may include:

a second streaming media channel establishing module 810 to establish a streaming media channel between the cloud server and a media projection device, wherein the first streaming media channel establishing module and the second streaming media channel establishing module of the media projection device cooperate to establish the streaming media channel;

a receiving module 820 to receive a media resource request message from the media projection device;

a sending module 830 to search for a corresponding media resource according to the media resource request message, and to send a found media resource to the media projection device over the streaming media channel.

The second streaming media channel establishing module 810 is further configured to establish a plurality of streaming media channels between the cloud server and a plurality of media projection devices respectively. Based thereon, the sending module 830 searches for the corresponding media resource according to the media resource request message, and sends the found media resource to the plurality of media projection devices over the plurality of streaming media channels respectively.

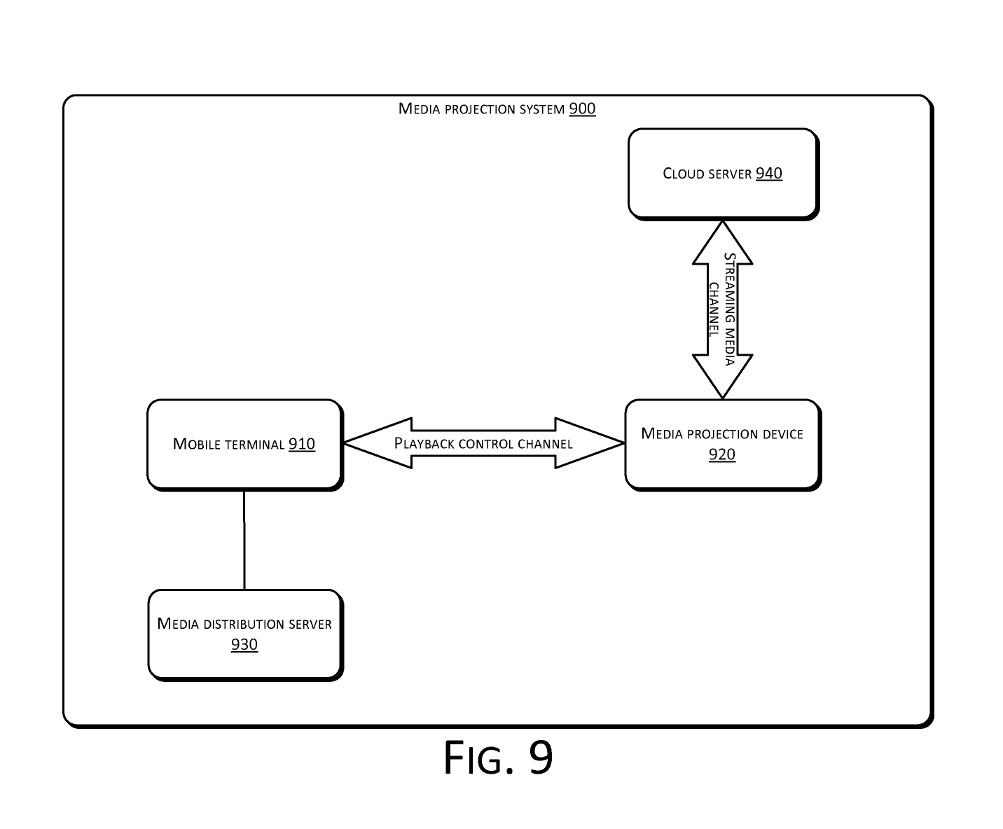

FIG. 9 shows a structural block diagram of a media projection system according to an embodiment of the present disclosure. The media projection system 900 may include: a control terminal 910 (such as a mobile device or terminal as shown in FIG. 9), at least one media projection device 920, a media distribution server 930, and a cloud server 940. For the purpose of simplification, only one media projection device is shown in FIG. 9.

A playback control channel is established between the control terminal 910 and the media projection device 920. The playback control channel is used for transmitting a media playback request message and/or a media control message. A streaming media channel is established between the media projection device 920 and the cloud server 940. The streaming media channel is used for transmitting media resource(s).

The control terminal 910 is connected with the media distribution server 930, and the control terminal 910 acquires media presentation information from the media distribution server 930. The media presentation information is media presentation information of media information that the control terminal currently presents or browses or that the user desires to acquire. In an embodiment, information presented by the control terminal 810 may correspond to a media resource played by the media projection device 920.

In a real application, the control terminal 910 generates a media playback request message. The media playback request message may include, for example, a media title (ID), a storage address or a download address, and other information. The control terminal 910 sends the media playback request message to the media projection device 920 over the playback control channel to request the media projection device 920 to enable a service of playing a corresponding media resource.

The media projection device 920 is connected with the cloud server 940. Upon receiving the media playback request message, the media projection device 920 sends a media resource request message for acquiring the media resource corresponding to the media playback request message to the cloud server 940. The request message may include, for example, the media title (ID), the storage address or the download address, and the other information of the media resource to be acquired.

In response to receiving the media resource request message, the cloud server 940 searches for the corresponding media resource, and sends the media resource that is found to the media projection device 920 over the streaming media channel. The media projection device 920 receives the media resource over the streaming media channel, and uses a player for playing the media resource to play the media resource.

In an event that the media projection device 920 does not have any player for playing the media resource, the media projection device 920 determines a type of the media resource, acquires a media player for playing media resources of the type from the cloud server 940, and uses the media player to play the media resource.

According to an embodiment of the present disclosure, the playback control channel and the streaming media channel are separately set up to transmit playback control commands and streaming media resources respectively, thereby achieving a smooth playback of the media resources, and avoiding stuttering especially a situation when a plurality of media projection devices are under control for performing playback at the same time.

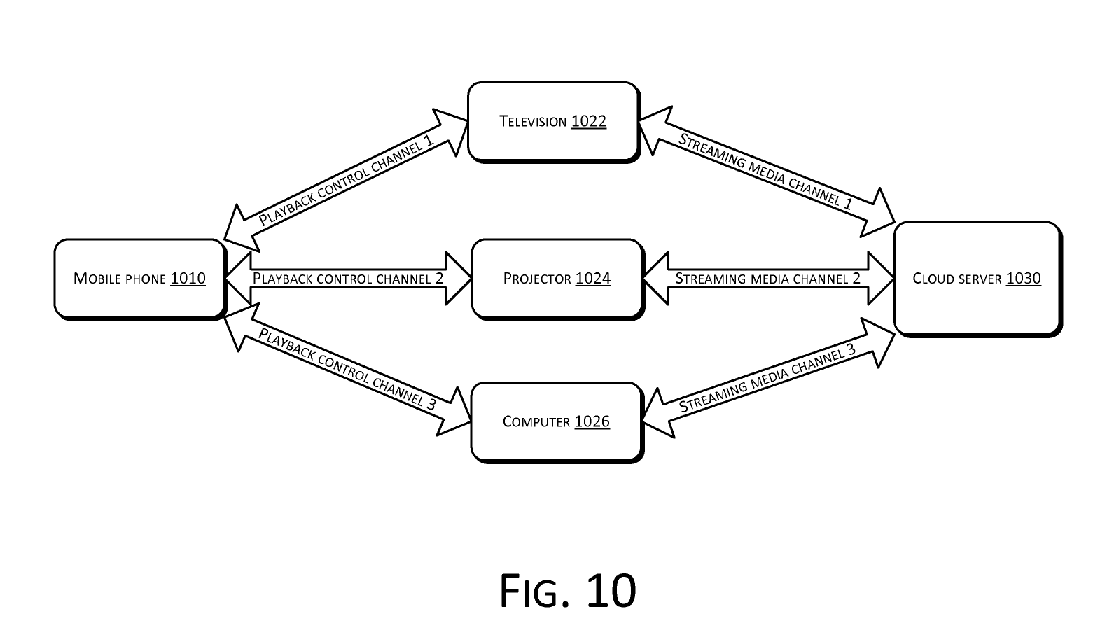

An application example of the present disclosure is described in detail herein with reference to FIG. 10. In this example, a control terminal controls a plurality of media projection devices to implement a synchronization of multi-party video playback. For example, a mobile phone 1010 controls a television 1022, a projector 1024 and a computer 1026 to play a video image synchronously among the three parties. Furthermore, these three devices may be disposed at different locations respectively. For example, the television is disposed in Beijing, the projector is disposed in Shanghai, and the computer is disposed in Hangzhou. The mobile phone, as the control terminal device, may either be disposed in one of the three cities or disposed in another city, which is not limited by the present disclosure.

First, the mobile phone 1010 establishes playback control channels with the television 1022, the projector 1024 and the computer 1026 respectively. The mobile phone 1010 establishes a TCP persistent connection according to an IP address and port of each device, and establishes the playback control channels on such basis. Specifically, the mobile phone 1010 establishes a playback control channel 1 with the television 1022, a playback control channel 2 with the projector 1024, and a playback control channel 3 with the computer 1026.

Moreover, the cloud server 1030 establishes streaming media channels with the television 1022, the projector 1024 and the computer 1026 respectively. Specifically, the cloud server 1030 establishes a streaming media channel 1 with the television 1022, a streaming media channel 2 with the projector 1024, and a streaming media channel 3 with the computer 1026.

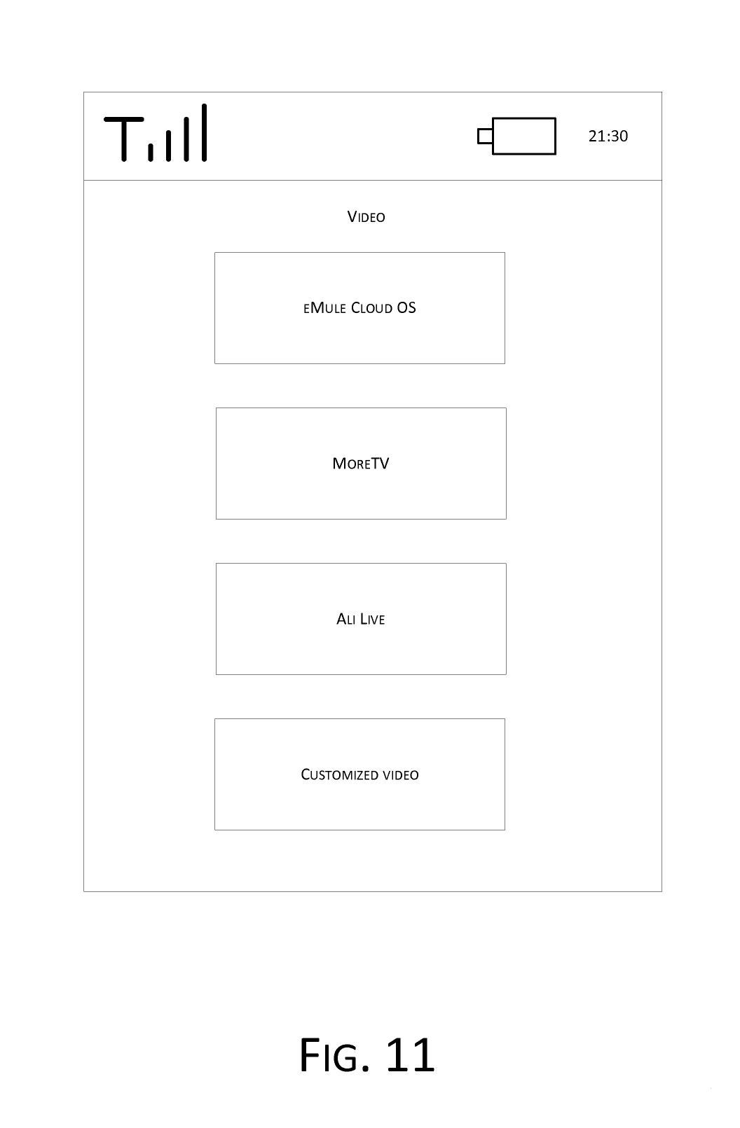

Acting as the control terminal device, the mobile phone 1010 may present video information that is to be played synchronously, for example, third-party video information acquired by the mobile phone 1010 from a media distribution server connected thereto, or information of a customized video that is downloaded by the mobile phone 1010 from another device such as a server. FIG. 11 shows a schematic diagram of a “video” application that presents video information in a mobile phone. A home page of the “video” application presents: home page links of third-party videos such as eMule, MoreTV, Ali Live, etc., that are acquired from the media distribution server. In response to receiving an instruction indicating that a user clicks on an icon URL, detailed video information included in a certain video is further presented, which, for example, may include video resources such as movies, television shows, news, etc.

If the user clicks on an icon of eMule Video, a presentation interface of eMule Video is entered via a URL of the icon, a video to be played such as a movie or a television show is selected, and a playback request message for playing a resource associated with the video is generated. The playback request message includes information such as an address for acquiring the video resource. The mobile phone 1010 sends a playback request message for playing the video to the television 1022, the projector 1024 and the computer 1026 via the playback control channels (1-3) respectively. If these three media projection devices need to play the video resource synchronously, the mobile phone 1010 sends a same playback request message.

After receiving the playback request message over the playback control channel 1, the television 1022 acquires a corresponding video resource from the cloud server 1030 according to the playback request message. Specifically, the television 1022 sends the playback request message to the cloud server 1030. The cloud server 1030 searches for the corresponding video resource locally according to an address of the video resource in the playback request message, and then sends a found video resource to the television 1022 over the streaming media channel 1. The television 1022 therefore uses a corresponding player to play the video resource. If the television 1022 does not have any player for playing the video resource, a video player corresponding to a type of the video resource is downloaded and installed from the cloud server 1030, so that the media projection device uses the corresponding media player to play the media resource content. For example, when the television 1022 plays a video resource provided by eMule Video, a video player corresponding to eMule Video needs to be used. In this case, the television 1022 sends identification information of the video player corresponding to eMule Video to the cloud server 1030. The cloud server 1030 sends the video player corresponding to the identification information (the video player of eMule Video) to the television 1022, so that the mobile phone 1022 downloads and installs the video player. Video resource playback processes of the projector 1024 and the computer 1026 are similar to that of the television 1022, and the details thereof are not redundantly described in detail herein. According to the above embodiment, the mobile phone 1010 can control the television 1022, the projector 1024 and the computer 1026 to play a video image having the same content synchronously.

In the above process, the video information that is played is provided by a third-party video. Alternatively, the user may specify to play a video resource captured or recorded thereby, or a video resource uploaded by another user to the cloud server 1030. Specifically, the user first uploads a video resource that needs to be synchronously played to the cloud server 1030, and an upload process may be implemented using the mobile phone 1010 or another apparatus. The mobile phone 1010 may then record information of an address at which the video resource is stored. Referring to FIG. 11, the home page of the “video” application may also present a home page link of a video customized by the user. After the user clicks an icon URL of the customized video, detailed video information included therein is further presented. For example, the mobile phone 1010 transmits in real time one or more pieces of video content that are acquired in real time to the cloud server for storage, and sends a playback request message for playing the real-time video to the controlled television 1022, the projector 1024 and the computer 1026 respectively. In response to receiving the playback request message, these three devices acquire a corresponding video resource from the cloud server 1030 and play the video resource. In this way, a synchronous video conference among three parties can be achieved.

In short, based on the foregoing technical solutions of the present disclosure, a unified playback control channel is established between a control terminal and a media projection device, and a media playback request message is sent over the playback control channel, so that the media projection device enables a service of playing a corresponding media resource according to the media playback request message, which implements multi-screen interaction of third-party videos rapidly and achieves personalized video playback and interaction experience while reducing the cost for development and maintenance of the third-party videos.

One skilled in the art should understand that the embodiments of the present disclosure can be provided as a method, a system or a computer program product. Therefore, the present disclosure can be implemented as an embodiment of only hardware, an embodiment of only software or an embodiment of a combination of hardware and software. Moreover, the present disclosure can be implemented as a computer program product that may be stored in one or more computer readable storage media (which includes but is not limited to, a magnetic disk, a CD-ROM or an optical disk, etc.) that store computer-executable instructions.

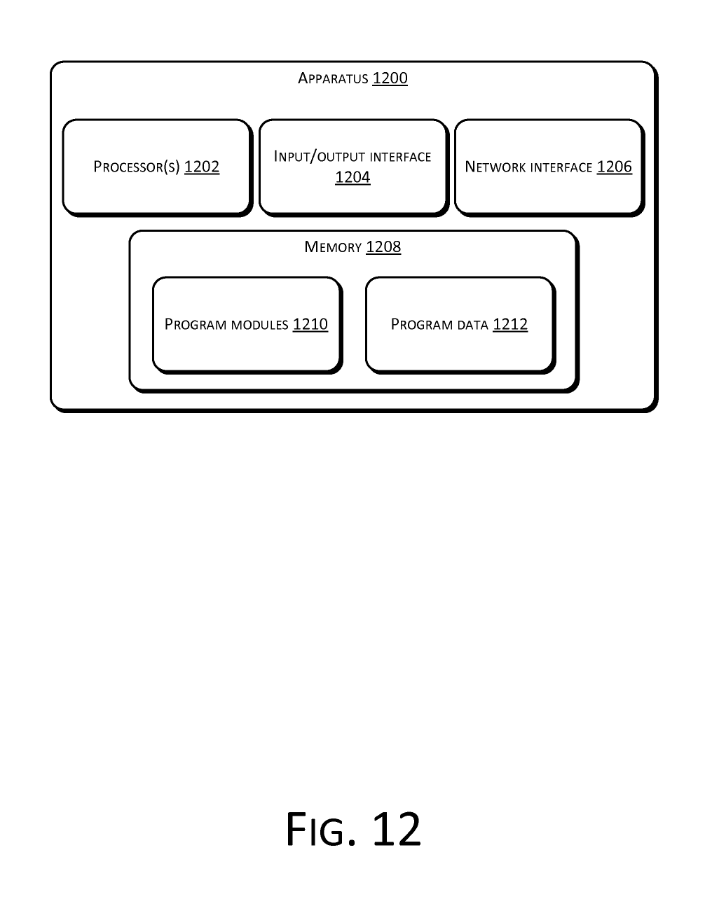

For example, FIG. 12 shows an example apparatus 1200, such as the control terminal, the media projection device, the cloud server, the media distribution server and the media projection system as described above, in more detail. In an embodiment, the apparatus 1200 may include, but is not limited to, one or more computing devices. For example, the apparatus 1200 may include one or more processors 1202, an input/output interface 1204, a network interface 1206, and memory 1208.

The memory 1208 may be a form of computer readable media, e.g., a non-permanent storage device, random-access memory (RAM) and/or a nonvolatile internal storage, such as read-only memory (ROM) or flash RAM. The memory is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an embodiment, the memory 1208 may include program modules 1210 and program data 1212. Depending on whether the apparatus 1200 corresponds to the control terminal 600, the media projection device 700, the cloud server 800 or the media projection system 900, the program modules 1210 of the apparatus 1200 may include one or more modules as described in the foregoing embodiments for a respective device, server or system. Details of these modules may be found in the foregoing description and are therefore not redundantly described herein.

It should also be noted that terms such as “comprise”, “include” or any other variations thereof are meant to cover the non-exclusive inclusions. The process, method, product or apparatus that includes a series of elements not only includes those elements, but also includes other elements that are not explicitly listed, or further includes elements that already existed in such process, method, product or apparatus. In a condition without further limitations, an element defined by the phrase “include a/an . . . ” does not exclude any other similar elements from existing in the process, method, product or apparatus.

The above descriptions are merely embodiments of the present disclosure, and are not intended to limit the present disclosure. For one skilled in the art, the present disclosure may have various types of modifications and variations. Any modification, equivalent replacement, improvement, etc., made within the spirit and principle of the present disclosure should be included in the scope of claims of the present disclosure.

1. A method implemented by a first device, the method comprising:
establishing a playback control channel with a second device; and
sending a media playback request message to the second device via the playback control channel to cause the second device to initiate a service of playing a media resource according to the media playback request message.

2. The method of claim 1, further comprising establishing a persistent connection between the first device and the second device, wherein the playback control channel is established over the persistent connection.

3. The method of claim 1, further comprising:
establishing one or more playback control channels between the first device and one or more other second devices; and
sending one or more media playback request messages to the one or more other second devices via the one or more playback control channels to cause the one or more other second devices to initiate a respective service of playing a respective media resource.

4. The method of claim 1, further comprising sending a media control message to the second device via the playback control channel to cause the second device to perform a media control operation according to the media control message.

5. The method of claim 4, wherein the media control message comprises a playback stop message and a playback switch message.

6. The method of claim 1, further comprising:
submitting a query for obtaining presentation information of the media resource to a media distribution server;
receiving the presentation information of the media resource from the media distribution server; and
presenting the media resource according to the presentation information.

7. The method of claim 1, further comprising:
establishing a plurality of playback control channels between the first device and a plurality of second devices; and
sending a plurality of media playback request messages to the plurality of second devices via the plurality of playback control channels to cause the plurality of second devices to play one or more media resources in synchronization with each other.

8. The method of claim 1, further comprising transmitting one or more pieces of video content from the first device to a cloud server for storage, wherein sending the media playback request message to the second device further causes the second device to obtain the one or more pieces of video content from the cloud server for playing the one or more pieces of video content in a display of the second device.

9. The method of claim 1, wherein the media resource comprises one or more of: a video, an audio, a picture and a web page.

10. The method of claim 1, further comprising:
obtaining an instance of inter-device communications with the second device after establishing the playback control channel with the second device; and
monitoring activities of the second device via the playback control channel.

11. The method of claim 10, further comprising:
detecting a message of activating a media player of the second device via the playback control channel; and
performing a corresponding operation on the second device, the corresponding operation comprising starting a projection of the media resource, stopping or switching a playback of the media resource.

12. The method of claim 10, further comprising:
detecting a message of disabling a media player of the second device via the playback control channel; and
discontinuing a projection of the media resource in the second device.

13. A first device comprising:
one or more processors;
memory;
a second playback control channel establishing module stored in the memory and executable by the one or more processors to establish a playback control channel between the first device and a second device;
a receiving module stored in the memory and executable by the one or more processors to receive a media playback request message from the second device over the playback control channel; and
a playback service module stored in the memory and executable by the one or more processors to enable a service of playing a media resource according to the media playback request message received by the receiving module.

14. The first device of claim 13, further comprising a first streaming media channel establishing module to establish a streaming media channel between the first device and a cloud server.

15. The first device of claim 14, wherein the playback service module sends to a media resource request message for acquiring the media resource from the cloud server according to the media playback request message, receives the media resource from the cloud server over the streaming media channel, and plays the media resource.

16. The first device of claim 13, further comprising a media player acquisition module to determine a type of the media resource, and to acquire a media player for playing media resources of the type from a cloud server, wherein the playback service module plays the media resource using the acquired media player.

17. The first device of claim 13, wherein the receiving module receives a media control message from the second device via the playback control channel, the media control message comprising one of a playback stop message or a playback switch message, wherein the playback service module performs a corresponding media control operation based on whether media control message comprises the playback stop message or the playback switch message.

18. One or more computer-readable media storing executable instructions that, when executed by one or more processors, cause the one or more processors to perform acts comprising:
establishing a streaming media channel between a cloud server and a media projection device;
receiving a media resource request message from the media projection device;
searching for a media resource according to the media resource request message; and
sending the media resource to the media projection device over the streaming media channel.

19. The one or more computer-readable media of claim 18, the acts further comprising:
establishing one or more streaming media channels between the cloud server and one or more other media projection devices; and
sending the media resource to the one or more other media projection devices over the one or more streaming media channels.

20. The one or more computer-readable media of claim 18, wherein the media resource comprises one or more of: a video, an audio, a picture and a web page.
